(19) United States
(12) Patent Application Publication
(10) Pub. No.: US 2018/0163694 A1
(43) Pub. Date: Jun. 14, 2018

(54) BLADE STRUCTURE OF WATER FLOW POWER GENERATION SYSTEM

(71) Applicant: CHIN-LI PAI, KAOHSIUNG (TW)

(72) Inventor: CHIN-YEN PAI, KAOHSIUNG CITY (TW)

(21) Appl. No.: 15/662,888

(22) Filed: Jul. 28, 2017

(30) Foreign Application Priority Data
Dec. 12, 2016 (TW) 105140979

(51) Int. Cl. F03B 17/06

(52) U.S. Cl. CPC F03B 17/062; F05B 2260/70; F05B 2240/302

(57) ABSTRACT

A blade structure of a water flow power generation system includes a blade body and a tail flap. The blade body has a side porion. The tail flap has a side connection portion. The side connection portion is pivotally connected to the side portion of the blade body.

### FIELD

The disclosure relates to a blade structure, more particular to a blade structure of a water flow power generation system.

### BACKGROUND

A water flow power generation system is a system that can generate power by using ocean currents, tides, or rivers, and needs to be equipped with a mechanism that can convert water flow kinetic energy into mechanical energy and electric energy in order. For example, in “sea-current power generation apparatus” of TW Patent No. 1526609, a mechanical energy is generated by pushing rotating blades by using water flows, and the mechanical energy is then converted into electric energy by using a power generator. However, the structure design of the foregoing rotating blades is not desirable. The rotating blades can work only in high-flowing speed (>3 is m/s) water flows, and cannot normally work if being placed in ocean currents or sea currents whose average flowing speed is lower than 1 m/s.

### SUMMARY OF THE INVENTION

In accordance with one aspect of the present disclosure, a blade structure of a water flow power generation system includes a blade body and a tail flap. The blade body has a side porion. The tail flap has a side connection portion. The side connection portion is pivotally connected to the side portion of the blade body.

### BRIEF DESCRIPTION OF THE DRAWINGS

Aspects of the present disclosure are understood from the following detail flaped description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 shows an exploded perspective view of a blade structure of a water flow power generation system in accordance with some embodiments of the present disclosure.

FIG. 2 shows an assembled perspective view of a blade structure of a water flow power generation system in accordance with some embodiments of the present disclosure.

FIG. 3A shows an enlarged view of a first pivoting component in accordance with some embodiments of the present disclosure.

FIG. 3B shows an enlarged view of a second pivoting component in accordance with some embodiments of the present disclosure.

FIG. 3C shows an enlarged view of an intermediate pivoting component in accordance with some embodiments of the present disclosure.

FIG. 4A shows a left side view of a blade structure of a water flow power generation system in accordance with some embodiments of the present disclosure. FIG.

FIG. 4B shows a right side view of a blade structure of a water flow power generation system in accordance with some embodiments of the present disclosure.

FIG. 5 shows an enlarged view of assembly of an intermediate angle restriction component and an intermediate pivoting component in accordance with some embodiments of the present disclosure.

FIG. 6A shows a left side view when a tail flap of a blade structure of a water flow power generation system swings upward in accordance with some embodiments of the present disclosure.

FIG. 6B shows a right side view when a tail flap of a blade structure of a water flow power generation system swings upward in accordance with some embodiments of the present disclosure.

FIG. 7A shows a left side view when a tail flap of a blade structure of a water flow power generation system swings downward in accordance with some embodiments of the present disclosure.

FIG. 7B shows a right side view when a tail flap of a blade structure of a water flow power generation system swings downward in accordance with some embodiments of the present disclosure.

FIG. 8 shows a schematic view of water flow action on a blade structure of a water flow power generation system in accordance with some embodiments of the present disclosure.

FIG. 9 shows a perspective view of a blade structure, additionally equipped with two side baffling plates, of a water flow power generation system in is accordance with some embodiments of the present disclosure.

FIG. 10 shows a schematic view of water flow action on a blade structure, additionally equipped with two side baffling plates, of a water flow power generation system in accordance with some embodiments of the present disclosure.

FIG. 11 shows a schematic structural view of a water flow power generation system using the blade structure in accordance with some embodiments of the present disclosure.

FIG. 12 shows a schematic view of blade action of a water flow power generation system using the blade structure in accordance with some embodiments of the present disclosure.

### DETAIL FLAPED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present disclosure to those of ordinary skill in the art. It will be apparent, however, that one or more embodiments may be practiced without these specific detail flaps.

In addition, the present disclosure may repeat reference numerals and/or letters in the various examples. This repetition is for the purpose of simplicity and clarity and does not in itself dictate a relationship between the various embodiments and/or configurations discussed.

It will be understood that singular forms “a”, “an” and “the” are intended to include the plural forms as well, unless the context clearly indicates otherwise.

Unless otherwise defined, all terms (including technical and scientific is terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

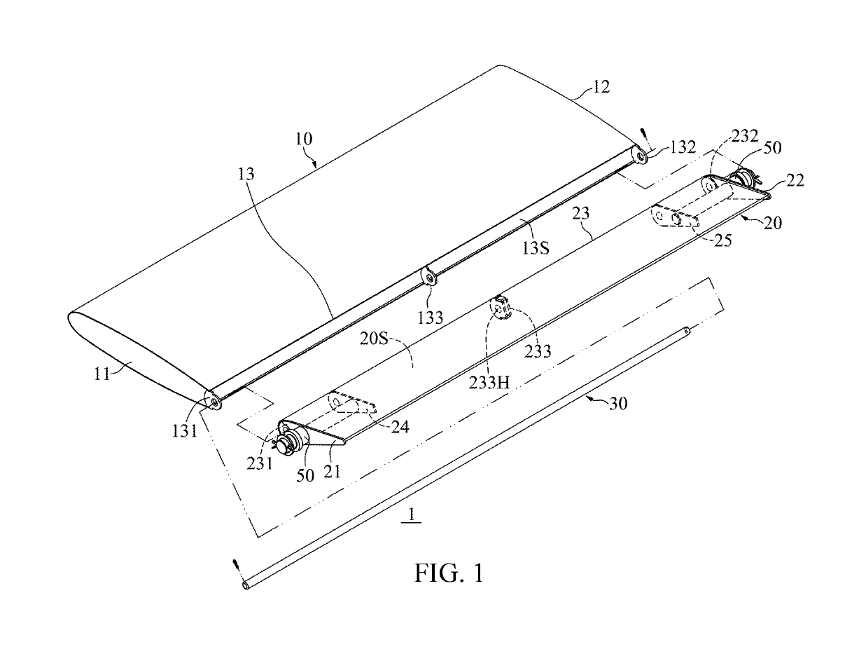

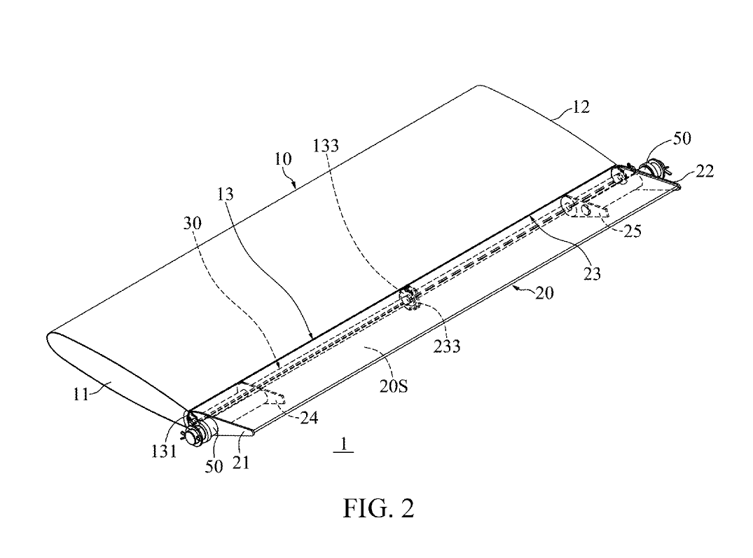

FIG. 1 shows an exploded perspective view of a blade structure of a water flow power generation system in accordance with some embodiments of the present disclosure. FIG. 2 shows an assembled perspective view of a blade structure of a water flow power generation system in accordance with some embodiments of the present disclosure. Referring to FIG. 1 and FIG. 2, a blade structure 1 of a water flow power generation system of the present disclosure includes a blade body 10 and a tail flap 20.

The blade body 10 has a first end portion 11, a second end portion 12, and a side portion 13. The second end portion 12 is opposite to the first end portion 11, and the side portion 13 extends between the first end portion 11 and the second end portion 12. The side portion 13 has a side surface 13S, a first pivoting component 131, and a second pivoting component 132. The first pivoting component 131 and the second pivoting component 132 are disposed on the side surface 13S in a protruding manner, and the first pivoting component 131 and the second pivoting component 132 are respectively located at two ends of the side portion 13.

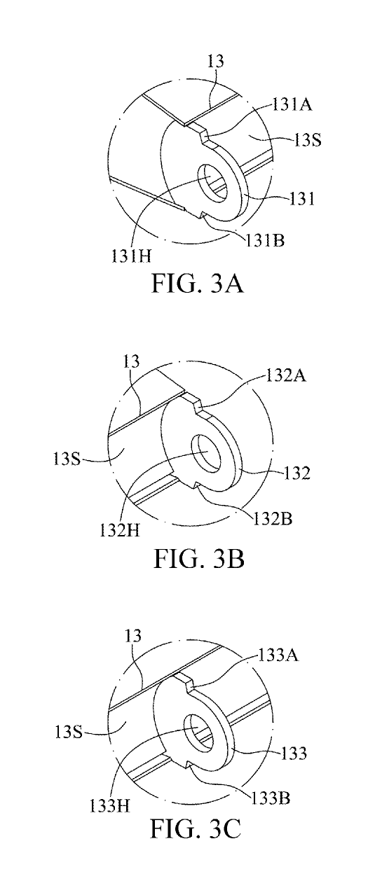

Referring to FIG. 3A, which shows an enlarged view of a first pivoting component in accordance with some embodiments of the present disclosure. The first pivoting component 131 has an upper baffling surface 131A, a lower baffling surface 131B, and a pivoting hole 131H. The pivoting hole 131H is located between the upper baffling surface 131A and the lower baffling surface 131B.

Referring to FIG. 3B, which shows an enlarged view of a second pivoting component in accordance with some embodiments of the present disclosure. The second pivoting component 132 has an upper baffling surface 132A, a lower baffling surface 132B, and a pivoting hole 132H. The pivoting hole 132H is located between is the upper baffling surface 132A and the lower baffling surface 132B.

Referring to FIG. 1 and FIG. 2 again, in one or more embodiments, the side portion 13 can further have an intermediate pivoting component 133. The intermediate pivoting component 133 is disposed on the side surface 13S in a protruding manner, and the intermediate pivoting component 133 is located between the first pivoting component 131 and the second pivoting component 132.

Referring to FIG. 3C, which shows an enlarged view of an intermediate pivoting component in accordance with some embodiments of the present disclosure. The intermediate pivoting component 133 has an upper baffling surface 133A, a lower baffling surface 133B, and a pivoting hole 133H. The pivoting hole 133H is located between the upper baffling surface 133A and the lower baffling surface 133B.

Referring to FIG. 1 and FIG. 2 again, the tail flap 20 has a first end plate 21, a second end plate 22, and a side connection portion 23. The second end plate 22 is opposite to the first end plate 21, and the side connection portion 23 extends between the first end plate 21 and the second end plate 22. In addition, the side connection portion 23 is pivotally connected to the side portion 13 of the blade body 10.

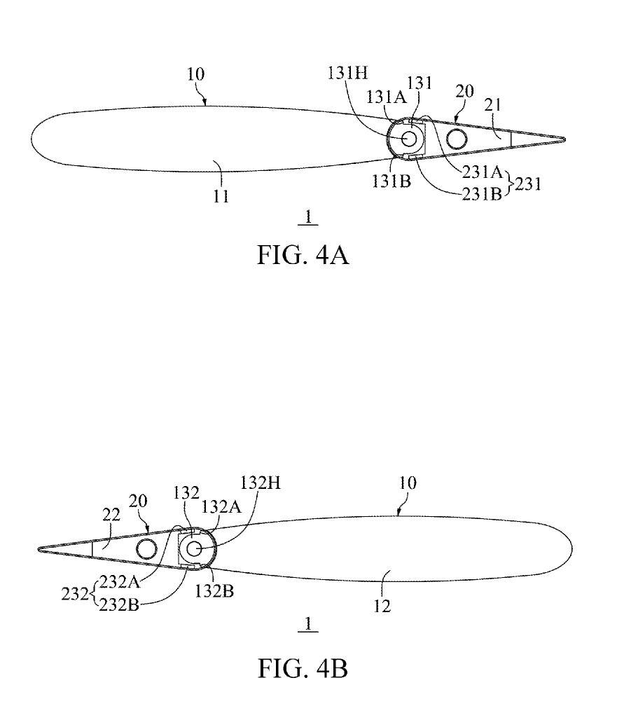

FIG. 4A shows a left side view of a blade structure of a water flow power generation system in accordance with some embodiments of the present disclosure. FIG. 4B shows a right side view of a blade structure of a water flow power generation system in accordance with some embodiments of the present disclosure. Referring to FIG. 1, FIG. 4A, and FIG. 4B, two ends of the side connection portion 23 respectively have a first angle restriction component 231 and a second angle restriction component 232.

The first angle restriction component 231 corresponds to the first pivoting component 131, and the first angle restriction component 231 includes an upper angle restriction block 231A and a lower angle restriction block 231B. The upper angle restriction block 231A corresponds to the upper baffling surface 131A of the first pivoting component 131, and the lower angle restriction block 231B is corresponds to the lower baffling surface 131B of the first pivoting component 131.

The second angle restriction component 232 corresponds to the second pivoting component 132, and the second angle restriction component 232 includes an upper angle restriction block 232A and a lower angle restriction block 232B. The upper angle restriction block 232A corresponds to the upper baffling surface 132A of the second pivoting component 132, and the lower angle restriction block 232B corresponds to the lower baffling surface 132B of the second pivoting component 132.

Referring to FIG. 1 and FIG. 2 again, in one or more embodiments, the side connection portion 23 can further have an intermediate angle restriction component 233, and the intermediate angle restriction component 233 corresponds to the intermediate pivoting component 133.

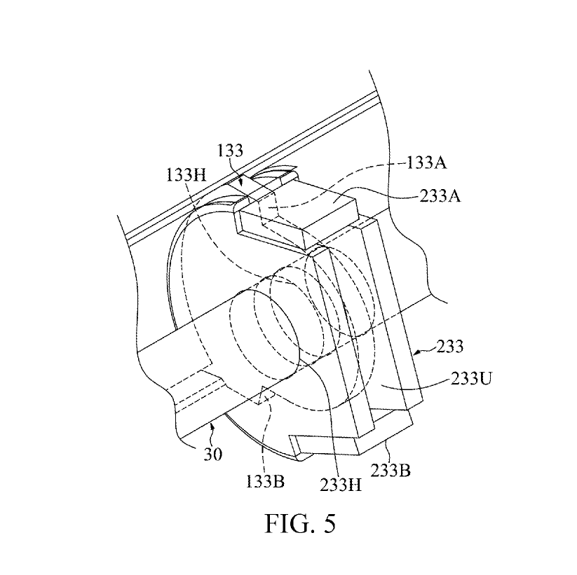

FIG. 5 shows an enlarged view of assembly of an intermediate angle restriction component and an intermediate pivoting component in accordance with some embodiments of the present disclosure. The intermediate angle restriction component 233 has a pivoting slot 233U and a connecting hole 233H, the intermediate pivoting component 133 is inserted in the pivoting slot 233U, and the pivoting hole 133H of the intermediate pivoting component 133 corresponds to the connecting hole 233H. Furthermore, the intermediate angle restriction component 233 includes an upper angle restriction block 233A and a lower angle restriction block 233B. The upper angle restriction block 233A corresponds to the upper baffling surface 133A of the intermediate pivoting component 133, and the lower angle restriction block 233B corresponds to the lower baffling surface 133B of the intermediate pivoting component 133.

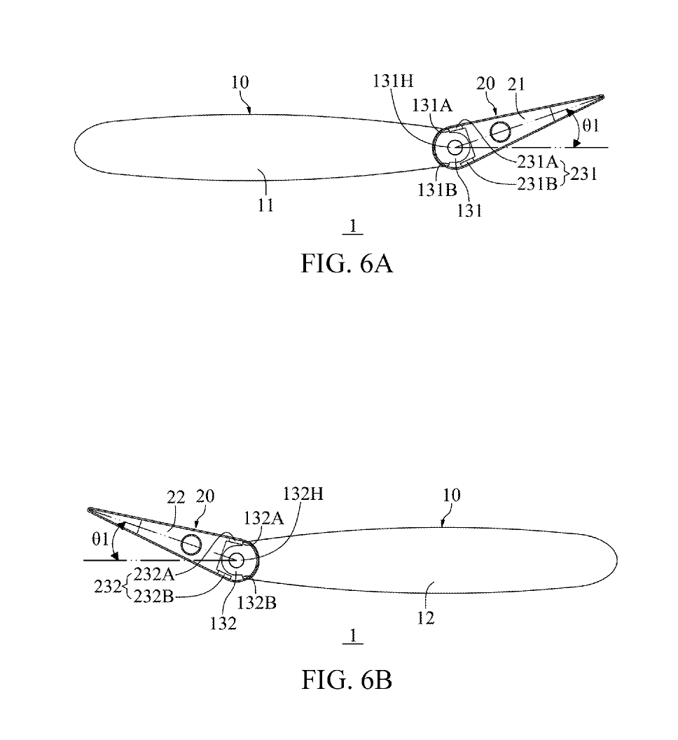

FIG. 6A shows a left side view when a tail flap of a blade structure of a water flow power generation system swings upward in accordance with some embodiments of the present disclosure. FIG. 6B shows a right side view when a tail flap of a blade structure of a water flow power generation system swings upward in accordance with some embodiments of the present disclosure. Referring to FIG. 5, FIG. 6A, and FIG. 6B, when the tail flap 20 swings upward, if the upper angle restriction block 231A of the first angle restriction component 231 abuts against the is upper baffling surface 131A of the first pivoting component 131, the upper angle restriction block 232A of the second angle restriction component 232 abuts against the upper baffling surface 132A of the second pivoting component 132, and the upper angle restriction block 233A of the intermediate angle restriction component 233 abuts against the upper baffling surface 133A of the intermediate pivoting component 133, it indicates that the tail flap 20 has swung to an upper dead point angle θ1.

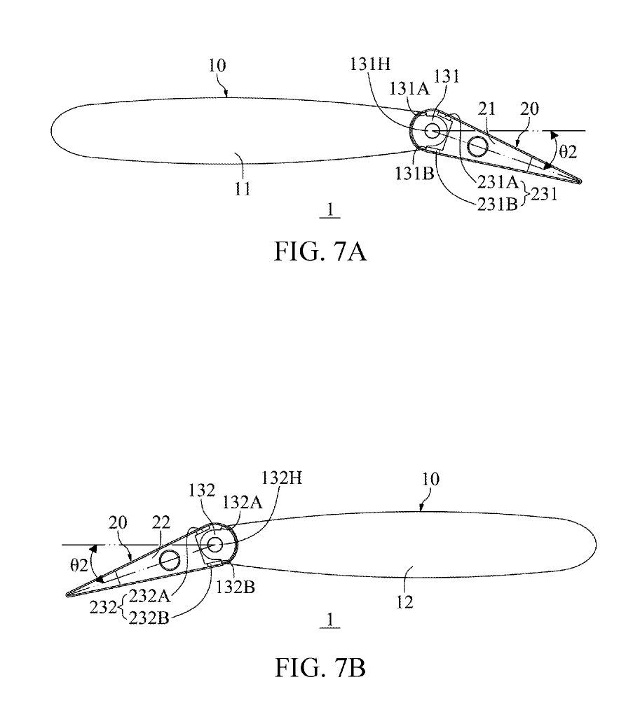

FIG. 7A shows a left side view when a tail flap of a blade structure of a water flow power generation system swings downward in accordance with some embodiments of the present disclosure. FIG. 7B shows a right side view when a tail flap of a blade structure of a water flow power generation system swings downward in accordance with some embodiments of the present disclosure. Referring to FIG. 7A and FIG. 7B, when the tail flap 20 swings downward, if the lower angle restriction block 231B of the first angle restriction component 231 abuts against the lower baffling surface 131B of the first pivoting component 131, the lower angle restriction block 232B of the second angle restriction component 232 abuts against the lower baffling surface 132B of the second pivoting component 132, and the lower angle restriction block 233B of the intermediate angle restriction component 233 abuts against the lower baffling surface 133B of the intermediate pivoting component 133 (not shown in the drawings), it indicates that the tail flap 20 has swung to a lower dead point angle θ2.

Referring to FIG. 6A and FIG. 7A again, in the present disclosure, an elevating force generated when the blade structure 1 of the water flow power-generation system is pushed by water flows can be optimized by controlling the upper dead point angle θ1 and the lower dead point angle θ2.

Referring to FIG. 1 and FIG. 2 again, in one or more embodiments, the blade structure 1 of the water flow power generation system can further include a pivoting rod 30. The pivoting rod 30 is configured to connect the side portion 13 of the blade body 10 to the side connection portion 23 of the tail flap 20, and preferably, the pivoting rod 30 extends through the side portion 13 of the blade body 10 and the side connection portion 23 of the tail flap 20.

Furthermore, to enable the pivoting rod 30 to be used as a pivot shaft when the tail flap 20 swings, the pivoting rod 30 extends through the first pivoting is component 131, the intermediate angle restriction component 233, the intermediate pivoting component 133, and the second pivoting component 132.

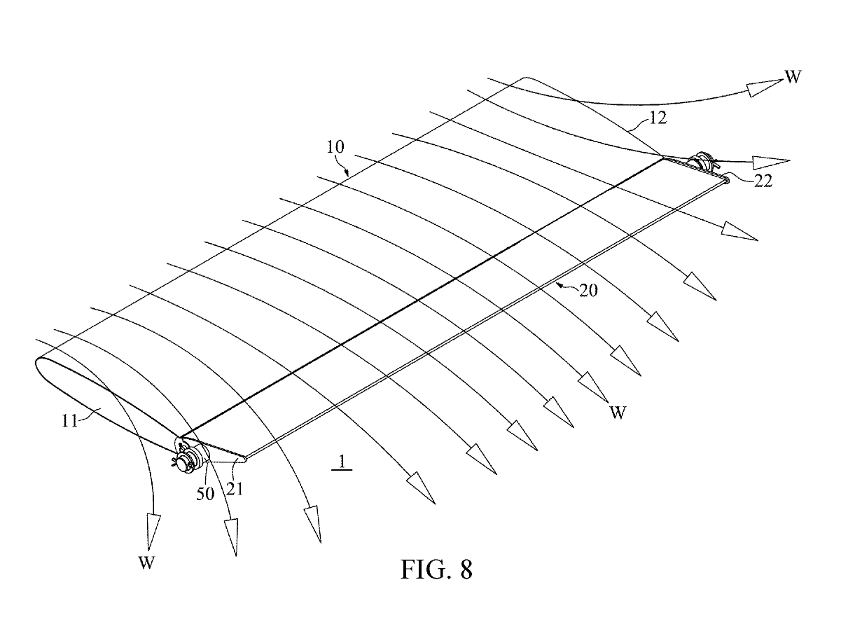

FIG. 8 shows a schematic view of water flow action on a blade structure of a water flow power generation system in accordance with some embodiments of the present disclosure. As shown in FIG. 8, a water flow W acts on the blade body 10 and the tail flap 20, and further generates detour flow at two ends of the blade structure 1 of the water flow power generation system. The detour flow causes loss of partial acting force of the water flow W, and forms eddy currents, which results in disorder of a flow field and vibration of the blade structure 1.

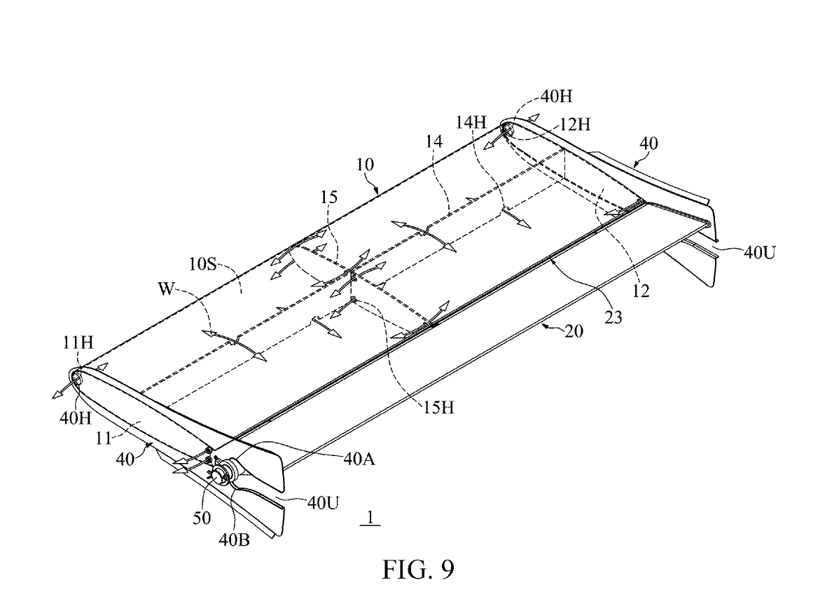

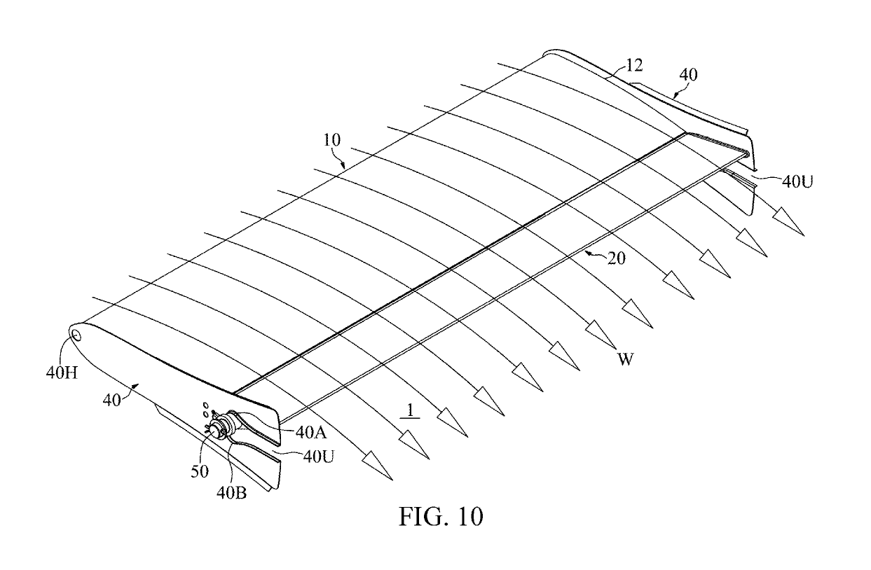

FIG. 9 shows a perspective view of a blade structure, additionally equipped with two side baffling plates, of a water flow power generation system in accordance with some embodiments of the present disclosure. FIG. 10 shows a schematic view of water flow action on a blade structure, additionally equipped with two side baffling plates, of a water flow power generation system in accordance with some embodiments of the present disclosure. Referring to FIG. 9 and FIG. 10, to prevent the detour flow from occurring, the blade structure 1 of the water flow power generation system can further include two side baffling plates 40. The two side baffling plates 40 are respectively disposed at the first end portion 11 and the second end portion 12 of the blade body 10, and a length of each of the side baffling plates 40 extends to the tail flap 20, so that the tail flap 20 is located between the two side baffling plates 40. As shown in FIG. 10, the two side baffling plates 40 can prevent the water flow W from generating detour flow at two ends of the blade structure 1 of the water flow power generation system, so that the water flow W can completely act on the blade body 10 and the tail flap 20, and reduce vibration of the blade structure 1.

Referring to FIG. 2 and FIG. 9, to further control a swing angle of the tail flap 20, in one or more embodiments, the blade structure 1 of the water flow power generation system can further include two connecting components 50, and each of two side baffling plates 40 may have a positioning slot 40U. The two connecting components 50 are respectively connected to the first end plate 21 and the second end plate 22 of the tail flap 20, and the two connecting components 50 respectively extend is through the positioning slots 40U of the side baffling plates 40. In addition, each of the positioning slots 40U has an upper baffling edge 40A and a lower baffling edge 40B, and each of the connecting components 50 can alternatively abut against each of the upper baffling edges 40A or each of the lower baffling edges 40B.

When the connecting components 50 abut against the upper baffling edges 40A, it indicates that the tail flap 20 has swung to an upper dead point angle.

When the connecting components 50 abut against the lower baffling edges 40B, it indicates that the tail flap 20 has swung to a lower dead point angle.

To further enhance the strength of the connection between the two connecting components 50 and the tail flap 20, in one or more embodiments, the tail flap 20 can have an internal space 20S, a first supporting plate 24, and a second supporting plate 25. The internal space 20S can reduce the weight of the tail flap 20. The first supporting plate 24 and the second supporting plate 25 are disposed in the internal space 20S, and the pivoting rod 30 also extends through the first supporting plate 24 and the second supporting plate 25. The two connecting components 50 respectively extend through the first end plate 21 and the second end plate 22, and the two connecting components 50 respectively have one end to connect to the first supporting plate 24 and the second supporting plate 25. By means of the connections between the two connecting components 50 and the first supporting plate 24 and the second supporting plate 25, the strength of the connection between the two connecting components 50 and the tail flap 20 can be greatly enhanced.

Furthermore, to reduce the weight of the blade body 10 and enhance the structure strength of the blade body 10, in one or more embodiments, the blade body 10 can have a hollow chamber 10S, an internal reinforcing rib 14, and an internal spacer plate 15. The hollow chamber 10S is located between the first end portion 11 and the second end portion 12, and the hollow chamber 10S can reduce the weight of the blade body 10. The internal reinforcing rib 14 is disposed in the hollow chamber 10S, and two ends of the internal reinforcing rib 14 are respectively connected to the first end portion 11 and the second end portion 12. The internal spacer plate 15 is also disposed in the hollow chamber 10S, and the internal spacer plate 15 is connected to the internal reinforcing rib 14. By means of disposing the internal reinforcing rib is 14 and the internal spacer plate 15, the structure strength of the blade body 10 can be enhanced.

In addition, when sinking deeper in water, the blade body 10 bears more external pressure. Therefore, in one or more embodiments, the first end portion 11 and the second end portion 12 can respectively have at least one perforation 11H and at least one perforation 12H, and the at least one perforation 11H and the at least one perforation 12H are in communication with the hollow chamber 10S. The water flow W can transfer the same pressure to the hollow chamber 10S through the at least one perforation 11H and the at least one perforation 12H, which can achieve a pressure balancing effect, and reduce the thickness and weight of a steel plate needed by the blade body 10 to resist pressure. Furthermore, the internal reinforcing rib 14 can have a plurality of slotted holes 14H, and the internal spacer plate 15 can have a plurality of through holes 15H. By means of the designs of the slotted holes 14H and the through holes 15H, the water flow W can flow more smoothly.

In addition, to prevent the two side baffling plates 40 from blocking the at least one perforation 11H and the at least one perforation 12H, in one or more embodiments, the two side baffling plates 40 respectively have at least one opening 40H, and the at least one opening 40H respectively corresponds to the at least one perforation 11H and the at least one perforation 12H, to keep the at least one perforation 11H and the at least one perforation 12H unblocked.

The following embodiments are used to describe in detail the working manner of the blade structure of the present disclosure during application in a water flow power generation system, but it does not mean that the present disclosure is only limited to the content disclosed by these embodiments.

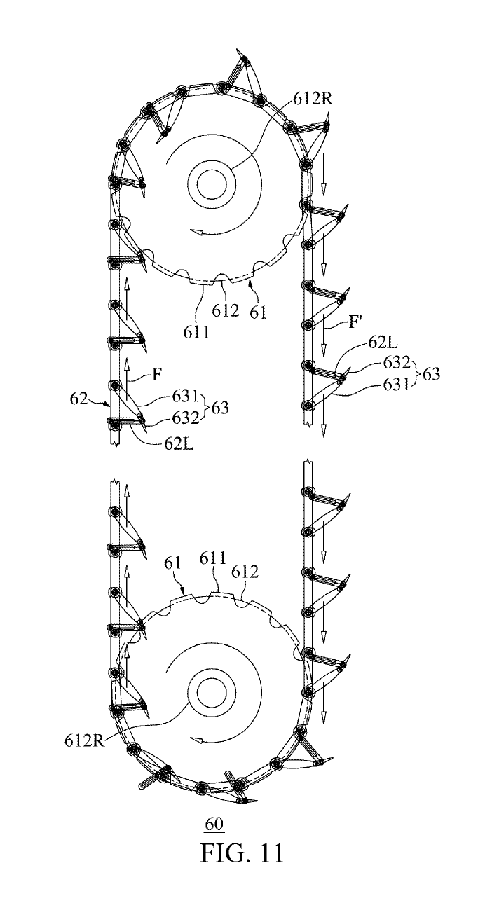

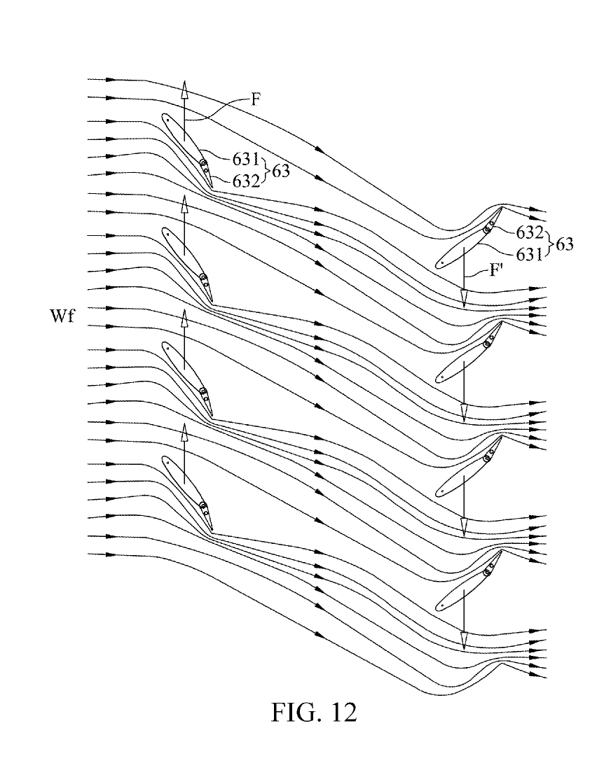

FIG. 11 shows a schematic structural view of a water flow power generation system using the blade structure in accordance with some embodiments of the present disclosure. FIG. 12 shows a schematic view of blade action of a water flow power generation system using the blade structure in accordance with some embodiments of the present disclosure. Referring to FIG. 11 and FIG. 12, the water flow power generation system 60 includes two power generating units 61, a transmission chain 62, and a plurality of blade structures 63.

The two power generating units 61 are spaced apart from each other along the vertical direction, and each of the power generating units 61 includes a transmission wheel 611 and a shaft power generator 612. A rotating shaft 612R of the shaft power generator 612 is connected to the transmission wheel 611, so that the transmission wheel 611 can drive the shaft power generator 612 to generate power while rotating.

The transmission chain 62 is engaged with the transmission wheels 611 of the power generating units 61, to synchronously drive the transmission wheels 611 to rotate. The transmission chain 62 has a plurality of positioning components 62L, and the positioning components 62L are disposed at intervals.

The blade structures 63 are disposed on the transmission chain 62 at intervals, and configured to convert a water flow pushing force Wf into an elevating force F, thereby driving the transmission chain 62 to rotate. Structural features of each of the blade structures 63 are the same as that of the blade structure 1 of the water flow power generation system. Therefore, each of the blade structures 63 also includes a blade body 631 (which is the same as the blade body 10) and a tail flap 632 (which is the same as the tail flap 20), and each tail flap 632 is connected to each positioning component 62L.

When the water flow pushing force Wf acts on a front column of the blade structures 63, the blade bodies 631 swing upward and the tail flaps 632 swing downward according to the action of the water flow pushing force Wf and the position differences of the rotation axles, and are positioned by the positioning components 62L, to convert the water flow pushing force Wf into the elevating force F, and push the transmission chain 62 to move upward. Then, the flowing directions of water flows that flow through the front column of the blade structures 63 are changed, and the water flow pushing force Wf continues to act on a rear column of the blade structures 63. Meanwhile, the blade bodies 631 change to swing downward and the tail flaps 632 change to swing upward due to the changed flowing directions and speeds, so as to obtain an elevating force F′. The elevating force F′ has a value close to a value of the elevating force F obtained from conversion by the front column of the is blade structures 63, and has a direction that is reverse to a direction of the elevating force F, so as to push the transmission chain 62 to move downward. In other words, the water flow pushing forces Wf in a same section can respectively act on the front column and rear column of the blade structures 63. By means of the transmission chain 62, the elevating forces F and F′ obtained from the conversion by the blade structures 63 can be accumulated, thereby achieving maximum power output.

The water flow power generation system 60 using the blade structure 63 of the present disclosure can normally work in ocean currents or sea currents whose average flowing speed is lower than 1 m/s, which facilitates wide development of ocean-current or sea-current power generation.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. A blade structure of a water flow power generation system, comprising:
a blade body having a side porion; and
a tail flap having a side connection portion, wherein the side connection portion is pivotally connected to the side portion of the blade body.

2. The blade structure of claim 1, further comprising a pivoting rod configured to connect the side portion of the blade body to the side connection portion of the tail flap.

3. The blade structure of claim 2, wherein the pivoting rod extends through the side portion of the blade body and the side connection portion of the tail flap.

4. The blade structure of claim 1, wherein the side portion of the blade body has a side surface, a first pivoting component, and a second pivoting component, the first pivoting component and the second pivoting component are disposed on the is side surface in a protruding manner, and the first pivoting component and the second pivoting component are respectively located at two ends of the side portion.

5. The blade structure of claim 4, wherein two ends of the side connection portion of the tail flap respectively have a first angle restriction component and a second angle restriction component, the first angle restriction component corresponds to the first pivoting component, and the second angle restriction component corresponds to the second pivoting component.

6. The blade structure of claim 5, wherein the first pivoting component has an upper baffling surface and a lower baffling surface, the first angle restriction component comprises an upper angle restriction block and a lower angle restriction block, the upper angle restriction block corresponds to the upper baffling surface, and the lower angle restriction block corresponds to the lower baffling surface.

7. The blade structure of claim 5, wherein the second pivoting component has an upper baffling surface and a lower baffling surface, the second angle restriction component comprises an upper angle restriction block and a lower angle restriction block, the upper angle restriction block corresponds to the upper baffling surface, and the lower angle restriction block corresponds to the lower baffling surface.

8. The blade structure of claim 4, further comprising a pivoting rod, wherein the pivoting rod extends through the first pivoting component and the second pivoting component.

9. The blade structure of claim 4, wherein the side portion further has an intermediate pivoting component, the intermediate pivoting component is disposed on the side surface in a protruding manner, and the intermediate pivoting component is located between the first pivoting component and the second pivoting component.

10. The blade structure of claim 9, wherein the side connection portion of the tail flap has an intermediate angle restriction component, and the intermediate angle restriction component corresponds to the intermediate pivoting component.

11. The blade structure of claim 10, wherein the intermediate angle is restriction component has a pivoting slot, and the intermediate pivoting component is inserted in the pivoting slot.

12. The blade structure of claim 11, further comprising a pivoting rod, wherein the pivoting rod extends through the intermediate angle restriction component and the intermediate pivoting component.

13. The blade structure of claim 9, wherein the intermediate pivoting component has an upper baffling surface and a lower baffling surface, the intermediate angle restriction component comprises an upper angle restriction block and a lower angle restriction block, the upper angle restriction block corresponds to the upper baffling surface, and the lower angle restriction block corresponds to the lower baffling surface.

14. The blade structure of claim 1, wherein the blade body has a hollow chamber and an internal reinforcing rib, and the internal reinforcing rib is disposed in the hollow chamber.

15. The blade structure of claim 14, wherein the blade body has a first end portion and a second end portion, and two ends of the internal reinforcing rib are respectively connected to the first end portion and the second end portion.

16. The blade structure of claim 14, wherein the blade body has an internal spacer plate, the internal spacer plate is disposed in the hollow chamber, and the internal spacer plate is connected to the internal reinforcing rib.

17. The blade structure of claim 1, further comprising two side baffling plates, wherein the blade body has a first end portion and a second end portion, and the two side baffling plates are respectively disposed at the first end portion and the second end portion.

18. The blade structure of claim 17, wherein the tail flap is located between the two side baffling plates.

19. The blade structure of claim 17, further comprising two connecting components, wherein the tail flap has a first end plate and a second end plate, and the two connecting components are respectively connected to the first end plate and the is second end plate.

20. The blade structure of claim 19, wherein the two side baffling plates respectively have a positioning slot, and the two connecting components respectively extend through the positioning slots.

21. The blade structure of claim 20, wherein each of the positioning slots has an upper baffling edge and a lower baffling edge, and each of the connecting components alternatively abuts against each of the upper baffling edges or each of the lower baffling edges.

22. The blade structure of claim 1, further comprising two connecting components, wherein the tail flap has a first end plate and a second end plate, and the two connecting components are respectively connected to the first end plate and the second end plate.

23. The blade structure of claim 22, wherein the two connecting components respectively extend through the first end plate and the second end plate.

24. The blade structure of claim 23, wherein the tail flap has an internal space, a first supporting plate, and a second supporting plate, the first supporting plate and the second supporting plate are disposed in the internal space, and the two connecting components respectively have one end to connect to the first supporting plate and the second supporting plate.

25. The blade structure of claim 24, further comprising a pivoting rod, wherein the pivoting rod extends through the first supporting plate and the second supporting plate.
